(19) United States
(12) Patent Application Publication
(10) Pub. No.: US 2021/0114537 A1
(43) Pub. Date: Apr. 22, 2021

(54) METHOD AND SYSTEM FOR SUPPLYING COMPRESSED AIR TO A VEHICLE AS REQUIRED, MORE PARTICULARLY A RAIL VEHICLE

(71) Applicant: KNORR-BREMSE SYSTEME FÜR SCHIENENFAHRZEUGE GMBH, Munich (DE)

(72) Inventors: Gert ASSMANN, Munich (DE); Christoph STROHMER, Munich (DE); Martin PRÖBSTL, Tutzing (DE)

(21) Appl. No.: 16/500,327

(22) PCT Filed: Apr. 3, 2018
(86) PCT No.: PCT/EP2018/058402

§ 371 Date: Oct. 2, 2019

(30) Foreign Application Priority Data
Apr. 5, 2017 (DE) 10 2017 107 276.4

(51) Int. Cl. B60R 16/08; B60T 17/02; B60T 17/22; B60T 15/02; B60L 1/00; B60T 17/00; B60T 13/26; B61H 13/00; B61C 17/00; F15B 15/20

(52) U.S. Cl. CPC B60R 16/08; B60T 17/02; B60T 17/228; B60T 15/021; B60L 1/003; B60T 17/004; B60L 9/00; B60T 13/26; B61H 13/00; B61C 17/00; F15B 15/20; B60T 2270/88; B60L 2200/26; B60T 17/221

(57) ABSTRACT

A method and system supply compressed air to a vehicle as required, more particularly a rail vehicle, wherein at least the primary air requirement of the rail vehicle for operating a pneumatic braking system is covered by a primary air compressor that is connected to a primary tank air line and wherein additional compressed air for operating auxiliary units is generated by at least one electromotive auxiliary air compressor having a lower delivery output than the primary air compressor. When the vehicle is parked, only the at least one auxiliary air compressor is used to generate compressed air as required, the air being used, whilst the vehicle is parked, to maintain permanent contact between a current collector that is actuated by a pneumatic actuating drive and an electric supply line.

### CROSS REFERENCE AND PRIORITY CLAIM

This patent application is a U.S. National Phase of International Patent Application No. PCT/EP2018/058402 filed Apr. 3, 2018, which claims priority to German Patent Application No. 10 2017 107 276.4, the disclosure of which being incorporated herein by reference in their entireties.

### FIELD

Disclosed embodiments relate to a method for supplying compressed air to a vehicle, in particular to a rail vehicle, according to demand, wherein at least the primary air demand of the rail vehicle for operating a pneumatic brake system is covered by a primary air compressor which is connected to a primary vessel air line, and wherein additional compressed air for operating secondary assemblies is generated by at least one auxiliary air compressor which is operated by electric motor and has a relatively low delivery output in comparison. Furthermore, disclosed embodiments also relates to a device with which such a method can be carried out and to a computer program product which embodies the method.

The field of use extends primarily to rail vehicles, mainly to electrically operated rail vehicles which use a pantograph to tap the electric energy required for operation from an electric overhead line. In addition to this first energy source in the high-voltage range, the vehicles which are of interest here also have a second energy source, for example in the form of one or more vehicle batteries, for storing electrical energy in the low-voltage range. The vehicle battery is provided for supplying electrical secondary assemblies if the first energy source is not available, and the vehicle battery is charged to a sufficient state of charge during the normal operation of the vehicle.

### BACKGROUND

The compressed air which is generated by the primary air compressor is primarily used to supply a pneumatic vehicle brake system. In the case of vehicles of the type of interest here, there are, in addition to such a primary air compressor, at least one auxiliary air compressor which has, compared to the primary air compressor, a much lower delivery output and smaller geometric dimensions. With the auxiliary air compressor it is possible to supply pneumatically operated secondary assemblies such as a sanding system, on-board toilets, air suspension system or also the actuator drive of a pantograph. However, such an auxiliary air supply occurs only in the normal mode, that is to say during travel or during short intermediate stops on the route.

### SUMMARY

Disclosed embodiments provide a method and a device for supplying compressed air to a vehicle according to demand, with which method and device it is possible to deploy a pantograph with low emission of noise during the shut-down mode of the vehicle. In addition, a computer program product is specified which specifies program code means for carrying out the method on an electronic control unit of the device.

### BRIEF DESCRIPTION OF THE FIGURES

Further measures which improve disclosed embodiments are illustrated in more detail below together with the description of disclosed embodiments with reference to the figures, of which:

FIG. 1 shows a schematic illustration of a device for supplying compressed air to a rail vehicle with a pantograph which can be activated pneumatically and has the purpose of supplying electrical energy, and

FIG. 2 shows a detail from the system according to FIG. 1 in the region of the primary vessel air line with connected sub-systems.

### DETAILED DESCRIPTION

Within the disclosed scope, a so-called shut-down mode in which the vehicle is shut down in the parked state overnight or over an even longer time period is differentiated herefrom.

DE 10 2015 113 940 A1 discloses a method and a device for providing a primary air supply and auxiliary air supply, in particular of a rail vehicle, with a compressor which is driven by means of an electric motor, in order to generate compressed air for filling at least one primary air vessel in order to supply pneumatic assemblies of the vehicle, wherein the vehicle has at least a first and a second energy source for supplying electrical energy. A pneumatic actuator drive is provided for setting up the vehicle and activating the first energy source with the compressed air generated by the compressor in that in this case the second energy source supplies the electric motor of the single compressor of the rail vehicle. A special switching valve device feeds the compressed air for deploying the pantograph to an auxiliary air vessel which is assigned to the pneumatic actuator drive, which switching valve device serves to supply compressed air for deploying the pantograph. Otherwise, the switching valve device feeds the compressed air generated by the compressor to the primary air vessel which is connected to a primary vessel air line.

A disadvantage with this technical solution is that slight leaks in the compressed air system can ensure that the auxiliary air vessel empties to such an extent that it is no longer possible to activate the pantograph by means of the pneumatic actuator drive. In this case of the undershooting of a lower limit in pressure, the compressor must be switched on in order to compensate for the pressure loss. Owing to its size, the compressor produces considerable noise which can cause nuisance to residents in the vicinity of the shut-down vehicle. If, in addition, it is to be ensured in specific application cases that the pantograph is in permanent contact with the electrical supply line during the entire shut-down mode, the compressor may also be switched on during the night. Permanent contact of the pantograph with the electrical supply line permits the vehicle to be kept operationally ready at all times. As a result, it is additionally possible to tap electrical current in order to prevent the vehicle becoming frozen up or the like under bad weather conditions by supplying heating devices.

If the compressor is used for the auxiliary air supply, the electrical energy of the vehicle battery can also be used for this, said electrical energy being fed to the three-phase motor of the compressor via an inverter. This permits the compressor to thus be driven with low power and with correspondingly low emission of noise compared to a full-load mode.

DE 10 2013 212 451 A1 discloses a device for supplying compressed air to a vehicle, in which device in addition to a primary air compressor an auxiliary air compressor is also provided with the, by comparison relatively low, delivery output for operating a toilet unit which is referred to here as a WC appliance. The compressed air which is required for this is fed via a primary vessel air line, wherein in addition an auxiliary air line is present for operating pneumatic secondary assemblies. The auxiliary air line is connected fluidically to the toilet unit via a bypass valve, in order to be able to use other compressed air from the primary vessel air line or auxiliary air line for rinsing the toilet unit. Details are not given on technical control measures for the compressed air supply to other secondary assemblies in this prior art.

Disclosed embodiments include the technical processing teaching that during the shut-down mode of the vehicle, exclusively the at least one auxiliary air compressor is used to generate on demand compressed air with which a pantograph which can be activated by means of pneumatic actuator drive is held in permanent contact on an electrical supply line during the shut-down mode.

In other words, this means that the primary air compressor remains shut down during the shut-down mode and is not activated until the shut-down mode has ended in order to change into the normal mode of the vehicle. This requires the compressed air vessels to be filled to a reference pressure level. If, on the other hand, compressed air is required during the shut-down mode owing to leakages or consumption of small amounts of air, in order to keep a pantograph in permanent contact on the electrical supply line, optionally just a single auxiliary air compressor is activated for this purpose. Owing to its low delivery output, said compressor causes much less emission of noise than a switched-on primary air compressor even if the latter is activated only on an auxiliary basis under battery operation. In addition, owing to the small overall size, an auxiliary air compressor can be encapsulated better and, if appropriate, integrated within the car of the rail vehicle.

According to a further measure which improves the disclosed embodiments, it is proposed that the compressed air which is generated by means of an auxiliary air compressor in the shut-down mode of the vehicle should be additionally used to compensate leakage losses in the primary vessel air line and/or sub-system, connected thereto, of the vehicle. Possible sub-systems are, for example, other pressure-medium-operated secondary assemblies such as a toilet rinsing system, sanding system, air suspension system. The primary vessel air line leads along the entire vehicle or vehicle train and is connected to at least one primary air vessel which serves to supply compressed air. The pressure consumers of the vehicle are connected to the primary vessel air line. These consumers also include the abovementioned sub-systems. Within this line network there is a feed pressure of approximately 8 to 10 bar present during normal mode. If a pressure loss occurs owing to a leak during the shut-down mode, the auxiliary air compressor can therefore be used for refilling. As a result, the readiness to drive during the shut-down mode is maintained without this requiring activation of the primary air compressor, which would cause a disadvantageously high emission of noise.

In this context, it is also proposed that in order to reduce the compressed air consumption as a result of leakage losses in the shut-down mode of the vehicle, the sub-systems may be entirely shut off from the primary vessel air line. This optional measure can be implemented, for example, by means of shut-down valves which are assigned to the sub-systems and which can be positioned as close as possible to the primary vessel air line. In addition it is also conceivable to uncouple the brake system from the primary vessel air line by means of shut-down valve during the shut-down mode of the vehicle in order to achieve the same object. The activation of shut-down valves which are provided for this can be carried out electromagnetically, or can be carried out pneumatically or hydraulically by pilot control. Furthermore it is advisable to monitor the switch position of the shut-down valves for diagnostic purposes.

According to another measure which improves the disclosed embodiments further, it is proposed that in the shut-down mode of the vehicle the switch-on pressure of a traction blocking unit of the vehicle is reduced compared to the normal mode. When the pressure in the primary vessel air line drops below 7 to 7.5 bar, a traction blocking unit prevents the vehicle from being started for safety reasons. This is because even when there is a sufficiently high pressure in the primary air line of a 8 to 10 bar, the brake system can function safely. Therefore, the traction blocking unit forms a disabling device when the pressure is insufficient. However, the abovementioned limiting pressure of the traction blocking unit does not need to be monitored or maintained during the shut-down mode of the vehicle, since in this state travel is not started in any case without the compressed air system having been previously filled by means of the primary air compressor. If the switch-on pressure of the traction blocking unit is reduced during the shut-down mode of the vehicle, a relatively high pressure loss as a result of leakage would be tolerable and the primary air compressor which according to the disclosed embodiments is used exclusively for refilling in the shut-down mode is subjected to lower switch-unloading. Nevertheless, safe parking braking can be ensured by optionally using spring-loaded brakes therefor.

Within the scope of the solution according to the disclosed embodiments, the primary air compressor is optionally supplied with the necessary electrical drive energy by means of the vehicle battery. To this extent, the primary air compressor can be embodied in a compact design by means of one structural unit of a one-cylinder piston compressor with an electric motor which is connected by a flange. In addition, it is also conceivable for the electric motor of the auxiliary air compressor to be embodied as a three-phase motor to which a frequency inverter is assigned for the battery operation with the vehicle battery. If an electrical overhead line contact is present, the auxiliary air compressor can, of course, also be switched over to overhead line supply, for which purpose in the case of a three-phase motor a voltage adaptation process is possible to be performed.

Furthermore, it is proposed that the primary air compressor which is used within the scope of the disclosed embodiments is provided with an air drier, arranged on the pressure outlet side, for dehumidifying the compressed air which is generated by the auxiliary air compressor. Such an air drier can be embodied, for example, as a single-chamber air drier or as a dual-chamber air drier or as a membrane drier. The selection of the suitable air drier is determined by the air delivery output and the insulation space which is available as well as the desired level of residual humidity in the compressed air which is generated by the auxiliary air compressor.

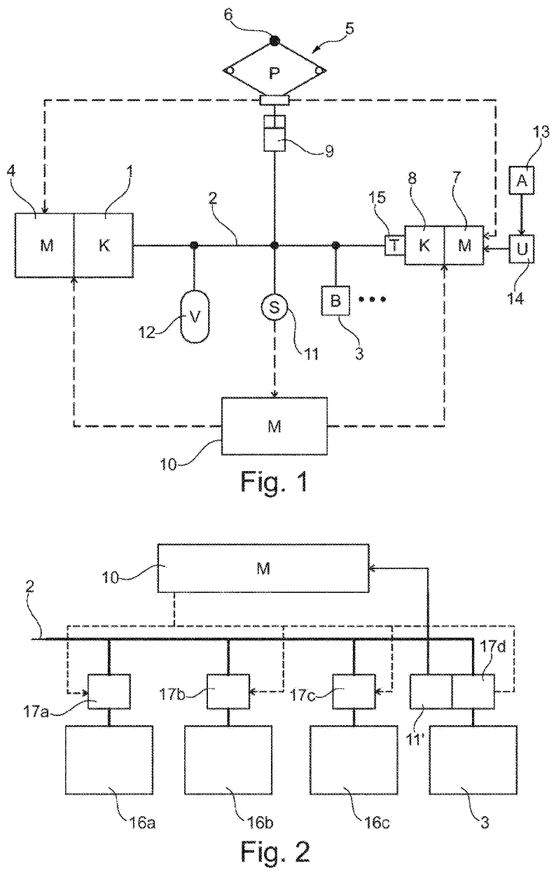

With this understanding of the technical utility of the disclosed embodiments in mind, FIG. 1 illustrates a device for supplying compressed air to a rail vehicle (not illustrated here in more detail) is composed of a primary air compressor 1 for supplying a primary vessel air line 2, running longitudinally through the rail vehicle, in order to cover the primary air demand of the rail vehicle, in order to operate the pneumatic brake system 3. The primary air compressor 1 is driven by a three-phase motor 4 which is connected to an electrical supply line 6 in order to supply electrical energy via a retractable pantograph 5—shown here in the extended state. Furthermore, an additional auxiliary air compressor 8 with delivery output which is relatively low compared to the primary air compressor 1 is provided a via a electric motor 7 which has smaller dimensions, in order additionally to generate compressed air for operating secondary assemblies. Furthermore, a pneumatic actuator drive 9 for supplying feed pressure is connected to the primary vessel air line 2. It is to be noted that for the sake of simplification the schematic drawing does not have any valves which are, of course, necessary for actuating the pressure medium assemblies.

The compressed air delivery of the primary air compressor 1 as well as the auxiliary air compressor 8 is actuated depending on the compressed air demand by means of a control unit 10. An exemplary sensor 11 is provided here for sensing the actual pressure in the primary vessel air line 2, which sensor 11 makes available this measured value to the control unit 10 for regulation purposes in a manner known per se. As a result, the actual pressure of a primary air vessel 12 which is connected to the primary vessel air line 2 and has the purpose of supplying compressed air can be monitored.

During the normal mode of the vehicle, the generation of compressed air occurs according to demand. This means that the primary air compressor 1 is started when it is necessary to refill the compressed air reservoir. This is achieved by dropping of the actual pressure measured by the sensor 11 below a limiting value below 8 bar.

On the other hand, compressed air losses which occur owing to a leakage during the shut-down mode of the vehicle cannot be compensated by starting the primary air compressor 1. Instead, according to the disclosed embodiments exclusively the auxiliary air compressor 8 is activated. As a result, in the event of a leakage it is possible to generate sufficient compressed air over the long time period of the shut-down mode in order to keep the pantograph 5 in permanent contact on the electrical supply line 6 using the pneumatic actuator drive 9.

In addition, the auxiliary air compressor 8 can also be used to compensate the leakage losses occurring in the shut-down mode of the vehicle on the primary vessel air line 2 and the sub-systems (not illustrated in more detail here) of the vehicle which are connected thereto.

In this exemplary embodiment the electrical energy supply of the electric motor 7 of the auxiliary air compressor 8 can be ensured by means of a vehicle battery 13. Since the electric motor 7 of the auxiliary air compressor 8 is embodied here as a three-phase motor, a frequency inverter 14 is intermediately connected for this battery operation. In addition, it is also possible to supply electric energy to the electric motor 7 of the auxiliary air compressor 8 directly via the supply line 6, but only when there is contact with an overhead line. Therefore, if a leak in the system of the primary vessel air line 2 during the shut-down mode should cause the pneumatic actuator unit 9 not to be retracted, which would result in a corresponding lowering of the pantograph 5 and therefore loss of contact by the supply line 6, electrical drive energy is available for the auxiliary compressor 8 via the latter, in order to compensate any losses of compressed air during the shut-down mode, for example on the part of the sub-systems.

In order to dehumidify the compressed air which is generated by the auxiliary air compressor 8, an air drier 15 in the form of a single-chamber drier is connected to the output side of the compressed air connection of the auxiliary air compressor 8.

According to FIG. 2, a number of exemplary sub-systems 16a to 16c, which are supplied via the primary vessel air line 2, are illustrated schematically. Furthermore, the pneumatic brake system 3 is also illustrated here, said brake system 3 also being supplied with pneumatic energy from the primary vessel air line 2.

In order to reduce the consumption of compressed air as a result of leakage losses in the system of the primary vessel air line 2 during the shut-down mode of the vehicle, the sub-systems 16a to 16c and the brake system 3 can be shut off from the primary vessel air line 2 by means of respectively assigned shut-down valves 17a to 17d. The switching on of the shut-down valves 17a to 17d occurs at the beginning of the shut-down mode of the vehicle by means of the control unit 10. Furthermore, the pressure in the brake system 3 is monitored separately by means of a sensor 11′ so that here the shut-down valve 17d can be connected upstream in order to reduce leakage losses. The sub-system 16a in this exemplary embodiment is a sanding unit, the sub-system 16b constitutes an air suspension unit and the sub-system 16c is a toilet which can be activated pneumatically. Of course, these can also be provided multiply.

The solution according to the disclosed embodiments is not restricted to the exemplary embodiment described above. Instead, refinements thereof which are also included in the scope of protection of the following claims are also conceivable. For example, it is therefore also possible for the pantograph to be considered to be a power collector unit which does not form electrical contact with a supply line which is embodied as an overhead line but rather with a power rail underneath the vehicle, in particular rail vehicle.

### LIST OF REFERENCE NUMBERS

1 Primary air compressor
2 Primary vessel air line
3 Pneumatic brake system
4 Electric motor for primary air compressor
5 Pantograph
6 Supply line
7 Electric motor for auxiliary air compressor
8 Auxiliary air compressor
9 Pneumatic actuator drive
10 Electronic control unit
11 Pressure sensor
12 Compressed air vessel
13 Vehicle battery
14′ Inverter
15 Air drier
16 Sub-system
17 Shut-down valve

1. A method for supplying compressed air to a rail vehicle according to demand, the method comprising:
providing at least a primary air demand of the rail vehicle for operating a pneumatic brake system by a primary air compressor, which is connected to a primary vessel air line; and
generating additional compressed air for operating secondary assemblies by at least one auxiliary air compressor, which is operated by electric motor and which has a relatively lower delivery output in comparison to the primary air compressor,
wherein, during shut-down mode of the rail vehicle, the at least one auxiliary air compressor is exclusively used to generate on demand compressed air with which a pantograph that is activatable by a pneumatic actuator drive is held in permanent contact on an electrical supply line during the shut-down mode.

2. The method of claim 1, further comprising using the compressed air generated by the auxiliary air compressor in the shut-down mode to compensate leakage losses on the primary vessel air line and/or vehicle sub-systems connected thereto.

3. The method of claim 2, further comprising shutting off the vehicle sub-systems from the primary vessel air line during the shut down mode to reduce the compressed air consumption as a result of leakage losses.

4. The method of claim 2, further comprising shutting off a brake system of the vehicle from the primary vessel air line during the shut down mode to reduce the compressed air consumption as a result of leakage losses.

5. The method of claim 1, wherein, in the shut-down mode, the switch-on pressure of a traction blocking unit of the vehicle is reduced in comparison to the switch-one pressure of the traction blocking unit of the vehicle in a normal mode.

6. A device for supplying compressed air to a rail vehicle according to demand, the device comprising:
a primary air compressor that provides at least a primary air demand of the rail vehicle for operating a pneumatic brake system, wherein the primary air compressor is connected to a primary vessel air line;
at least one auxiliary air compressor that generates additional compressed air for operating secondary assemblies, wherein the at least one auxiliary air compressor is operated by electric motor and has a relatively lower delivery output in comparison to the primary air compressor; and
a control unit configured to activate exclusively the at least one primary air compressor (8) to generate compressed air on demand for a pneumatic actuator drive of a pantograph during the shut-down mode of the vehicle to ensure permanent contact on an electrical supply line during the shut-down mode.

7. The device of claim 6, further comprising a pressure sensor that monitors pressure in the primary vessel air line to enable compensation for leakage losses occurring on the primary vessel air line in the shut-down mode of the vehicle and in vehicle sub-systems connected to the primary vessel air line using compressed air generated by the primary air compressor.

8. The device of claim 7, further comprising shut-down valves provided in connection to the primary vessel air line, wherein, to reduce compressed air consumption by leakage losses in the shut-down mode of the vehicle, the vehicle sub-systems and/or a brake system are uncoupled from the primary vessel air line by the respectively assigned shut-down valves.

9. The device of claim 6, further comprising an electric motor and a vehicle battery that supplies electrical drive energy to the electric motor, which drives the at least one auxiliary air compressor.

10. The device claim 9, characterized in that the electric motor is a three-phase motor to which a frequency inverter is assigned to operate the battery.

11. The device of claim 6, further comprising an air drier for dehumidifying the compressed air generated by the at least one auxiliary air compressor.

12. A non-transitory computer program product including program code for carrying out a method for supplying compressed air to a rail vehicle according to demand when the computer program code runs on a control unit, the method comprising:
providing at least a primary air demand of the rail vehicle for operating a pneumatic brake system by a primary air compressor, which is connected to a primary vessel air line; and
generating additional compressed air for operating secondary assemblies by at least one auxiliary air compressor, which is operated by electric motor and which has a relatively lower delivery output in comparison to the primary air compressor,
wherein, during shut-down mode of the rail vehicle, the at least one auxiliary air compressor is exclusively used to generate on demand compressed air with which a pantograph that is activatable by a pneumatic actuator drive is held in permanent contact on an electrical supply line during the shut-down mode.

13. The non-transitory computer program product of claim 12, wherein the method further comprises using the compressed air generated by the auxiliary air compressor in the shut-down mode to compensate leakage losses on the primary vessel air line and/or vehicle sub-systems connected thereto.

14. The non-transitory computer program product of claim 13, wherein the method further comprises shutting off the vehicle sub-systems from the primary vessel air line during the shut down mode to reduce the compressed air consumption as a result of leakage losses.

15. The non-transitory computer program product of claim 13, wherein the method further comprises shutting off a brake system of the vehicle from the primary vessel air line during the shut down mode to reduce the compressed air consumption as a result of leakage losses.

16. The non-transitory computer program product of claim 12, wherein, in the shut-down mode, the switch-on pressure of a traction blocking unit of the vehicle is reduced in comparison to the switch-one pressure of the traction blocking unit of the vehicle in a normal mode.
